(19) United States
(12) Patent Application Publication
(10) Pub. No.: US 2026/0052491 A1
(43) Pub. Date: Feb. 19, 2026

(54) METHOD FOR SYNCHRONIZING NODES OF A CELLULAR NETWORK

(71) Applicant: Deutsche Telekom AG, Bonn (DE)

(72) Inventors: Helmut IMLAU, Langwedel (DE); Josep COLOM IKUNO, Korneuburg (AT)

(21) Appl. No.: 19/100,986

(22) PCT Filed: Aug. 15, 2023
(86) PCT No.: PCT/EP2023/072464

§ 371 Date: Feb. 4, 2025

(30) Foreign Application Priority Data
Aug. 17, 2022 (EP) 22190780.1

(51) Int. Cl. H04W 56/00; H04J 3/06

(52) U.S. Cl. CPC H04W 56/0015; H04J 3/0667

(57) ABSTRACT

A method for synchronizing nodes of a cellular network includes: a base transceiver station (BTS), as a first node of a cellular network, wirelessly transmits clock information to a terminal device connected to the cellular network as a second node of the cellular network according to a first communication protocol; and the BTS transmits clock accuracy information to the terminal device according to the first communication protocol, wherein the clock accuracy information is specified by a second communication protocol different from the first communication protocol.

### CROSS-REFERENCE TO PRIOR APPLICATIONS

This application is a U.S. National Phase application under 35 U.S.C. § 371 of International Application No. PCT/EP2023/072464, filed on Aug. 15, 2023, and claims benefit to European Patent Application No. EP 22190780.1, filed on Aug. 17, 2022. The International Application was published in English on Feb. 22, 2024 as WO 2024/038050 A1 under PCT Article 21(2).

### FIELD

The invention relates to a method for synchronizing nodes of a cellular network wherein a base transceiver station (BTS) as first node of a cellular network wirelessly transmits clock information to a terminal device connected to the cellular network as a second node of the cellular network according to a first communication protocol. The invention further relates to a computer program product.

The method allows for synchronizing a terminal device, i.e. user equipment (UE) connected to a cellular network with the cellular network. Synchronization is achieved by distributing clock information, e.g. a UTC timestamp, within the cellular network, i.e. transmitting the clock information between nodes of the cellular network.

### BACKGROUND

A cellular network generally comprises a plurality of BTS each BTS being a node of the cellular network and establishing a cell of the cellular network. The cell comprises a portion of the earth's surface allowing a terminal device with a radio interface to wirelessly connect to the BTS, i.e. connect to the cellular network “over the air”. Terminal devices connected to a BTS of the cellular network are also considered nodes of the cellular network herein.

The BTS needs to know a time in order to distribute the clock information to a connected terminal device. The BTS may receive the clock information from a global navigation satellite system (GNSS). The BTS may receive the clock information also from a third node of the cellular network, e.g. according to the precision time protocol (PTP). The BTS usually executes a PTP client for receiving the clock information from the third node.

It is noted that the term “protocol” shall be understood in the usual way, i.e. a protocol specifies a plurality of rules allowing two or more nodes to transmit information between each other via a varying physical quantity. The protocol may specify the rules, syntax, semantics and/or synchronicity of the transmitted information. Different protocols may relate to different network layers and/or different networking planes.

The BTS may wirelessly transmit the received clock information to the terminal device according to a communication protocol different from PTP, e.g. according to a 5G communication protocol as specified by the 3GPP partnership project, 3GPP.

The BTS may additionally provide a clock accuracy information.

The 3GPP draft “KI#1, Sol#1: Update to remove ENs” published May 6, 2022 discloses a method for separately transmitting clock information and clock accuracy information by radio resource control (RRC) and precision time protocol ((g)PTP), respectively, to the terminal device wherein the clock accuracy information is forwarded to and consumed by devices attached to the terminal device.

WO 2021/181363 A1 discloses a method for wirelessly transmitting a clock accuracy information to a terminal device using at least one of a plurality of different communication protocols.

However, the 5G communication protocol actually does not allow the BTS for transmitting the clock accuracy information to the terminal device. As a consequence, the terminal device is prevented from taking into account a precision of the synchronization.

### SUMMARY

In an exemplary embodiment, the present invention provides a method for synchronizing nodes of a cellular network. The method includes: a base transceiver station (BTS), as a first node of a cellular network, wirelessly transmits clock information to a terminal device connected to the cellular network as a second node of the cellular network according to a first communication protocol; and the BTS transmits clock accuracy information to the terminal device according to the first communication protocol, wherein the clock accuracy information is specified by a second communication protocol different from the first communication protocol.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 schematically shows a partial diagram of a cellular network synchronized by a method according to the invention.

### DETAILED DESCRIPTION

Exemplary embodiments of the invention provide a method for synchronizing nodes of a cellular network which efficiently allows the BTS for wirelessly transmitting a clock accuracy information to a terminal device and allows the terminal device for efficiently receiving the clock accuracy information. Exemplary embodiments of the invention further provide a computer program product.

A first aspect of the invention is a method for synchronizing nodes of a cellular network wherein a base transceiver station, BTS, as first node of a cellular network wirelessly transmits clock information to a terminal device connected to the cellular network as a second node of the cellular network according to a first communication protocol. The transmitted clock information synchronizes the terminal device with the BTS. The first communication protocol may be a 5G communication protocol specified by 3GPP, particularly the access stratum, AS, layer of the radio access network, RAN.

According to the invention, the BTS transmits a clock accuracy information to the terminal device according to the first communication protocol, the clock accuracy information specified by a second communication protocol different from the first communication protocol. In other words, the first communication protocol is used for additionally transmitting the clock accuracy information although the clock accuracy information is specified by a second communication protocol and provided in accordance with the second communication protocol.

Thus, the transmission of the clock accuracy information relies on an available single communication protocol despite the different communication protocol defining the clock accuracy information to be transmitted. On the one hand, there is no need of the wireless connection for supporting the second communication protocol. On the other hand, no additional communication protocol has to be specified for transmitting the clock accuracy information. Accordingly, the method may be implemented very efficiently.

In an embodiment, a network layer of the first communication protocol is different from a network layer of the second communication protocol and/or wherein a networking plane of the first communication protocol is different from a networking plane of the second communication protocol. The network layers are specified by the open systems interconnection, OSI, model. For instance, the first communication protocol applies to layer 3, the so-called network layer, and the second communication protocol applies to layer 7, the so-called application layer. The networking planes are components of an architecture of cellular networks and comprise a control plane and a user plane, the latter also called data plane, forwarding plane, carrier plane or bearer plane. The control plane comprises a management plane as a subset.

In typical cellular networks, the user plane supports transmission of application data, e.g. internet data, and requires a protocol data unit, PDU, session which is established in the control plane which supports signaling traffic. While the control plane is independent from the user plane, the user plane depends on the control plane. Control plane transmissions between the BTS and the terminal device take place according to access stratum layer protocols. Control plane transmissions between a core server of the cellular network and the terminal device take place according to non-access stratum, NAS, layer protocols.

Preferably, each of the clock information and the clock accuracy information is transmitted according to the radio resource control, RRC, protocol as the first communication protocol and the clock accuracy information is specified by the precision time protocol, PTP, as the second communication protocol. Using the PTP clock accuracy information avoids a redundant definition and a transformation between different definitions of the clock accuracy information. Apart from that, both the BTS and the terminal device usually are PTP capable.

The BTS may transmit the PTP clock accuracy information as a part of an RRC message and/or an RRC information specified by the RRC protocol. The RRC message and the RRC information are classes of data entities specified by the RRC protocol. RRC messages and/or RRC information are related to the AS layer.

Preferably, the BTS transmits the PTP clock accuracy information as a part of a master information block, MIB, specified by the RRC protocol or as a part of a system information block, SIB, specified by the RRC protocol. Transmission of the PTP clock accuracy information relies on a MIB or SIB specified by the RRC protocol, 3GPP TS 38.331 6.2.2 or 3GPP TS 38.331 6.3.1. SIBs are transmitted periodically or in response to a request from the terminal device.

The BTS may transmit the PTP clock accuracy information as a part of a SIB1 or as a part of a SIB9 specified by the RRC protocol. The SIB1 is specified by 3GPP TS 38.331 6.2.2. The SIB9 is specified by 3GPP TS 38.331, 6.3.2. It is noted that the clock information is transferred in the SIB9.

In an embodiment, the BTS transmits the PTP clock accuracy information via a broadcast channel, BCH, or via a download shared channel, DL-SCH.

Advantageously, a PTP client of the BTS receives a PTP announce message from a third node of the cellular network and transmits content of the received PTP announce message as the PTP clock accuracy information. The PTP announce message is specified by IEEE 1588 and comprises quality information concerning the clock. The third node may be configured as a core server of the cellular network. The BTS may receive a different clock accuracy information and transform the different clock accuracy information into a PTP clock accuracy information.

A clockClass value, a clockAccuracy value and/or an offsetScaledLog Variance value may be transmitted as the content. The clockClass value specifies a state of a local clock. The clockAccuracy value specifies an estimated time error. The offsetScaledLog Variance value specifies a variance of the clock information.

A PTP master executed by the terminal device may receive the PTP clock accuracy information. The PTP master may take into account a precision of the synchronization or forward the PTP clock accuracy information to a PTP client. The PTP clock accuracy information may alternatively be forwarded according to another specification different from PTP.

In an embodiment, a PTP client of a user application executed by the terminal device receives the PTP clock accuracy information from the PTP master. The user application may take into account a precision of the synchronization. Alternatively, a PTP client of another device connected to the terminal device or a PTP client of a user application executed by the other device may receive the PTP clock accuracy information. The received PTP clock accuracy information may be used for raising an alert or enabling the terminal device or the other device to select an optimal time source.

The terminal device or a user application executed by the terminal device may execute a best master clock algorithm, BMCA, dependent of the received PTP clock accuracy information. The BMCA is a time source selection algorithm specified by IEEE 1588 and allows the terminal device for selecting a PTP grandmaster, GM, i.e. a timing reference, dependent of the provided accuracy of the clock information.

The clock accuracy information is preferably transmitted once a second. Once a second is a transmission rate being sufficient for the clock accuracy information while not causing a heavy load for the wireless connection.

In an embodiment, a gNodeB transmits the clock accuracy information as the BTS. The gNodeB is a 5G base station.

A second aspect of the invention is a computer program product, comprising a computer-readable medium storing a program code. The computer-readable medium comprises a digital storage unit, e.g. a USB stick, a digital versatile disk, DVD, a hard disk, a random access memory, RAN, chip, an internet cloud and the like.

According to the invention, the program code causes a computing device to participate in a method according to the invention as a BTS or as a terminal device when being executed by a processor of the computing device. The computing device reads the program code stored by the computer-readable medium and executes the read program code. The read program code enables the computing device to carry out the method either as the BTS or as the terminal device. The computing device may be configured as a server hardware or a smartphone and the like, respectively.

It is an advantage of the invented method that the method may be implemented very efficiently. On the one hand, there is no need of the wireless connection for supporting the second communication protocol. On the other hand, no additional communication protocol has to be specified for transmitting the clock accuracy information. Apart from that, an existing clock accuracy definition may be used and transformations between different definitions of clock accuracy information are avoided.

Further advantages and configurations of the invention become apparent from the following description and the enclosed drawings.

It shall be understood that the features described previously and to be described subsequently may be used not only in the indicated combinations but also in different combinations or on their own without leaving the scope of the present invention.

The invention is described in detail via an exemplary embodiment and with reference to the drawings. Like components are indicated by like reference numerals throughout the drawings.

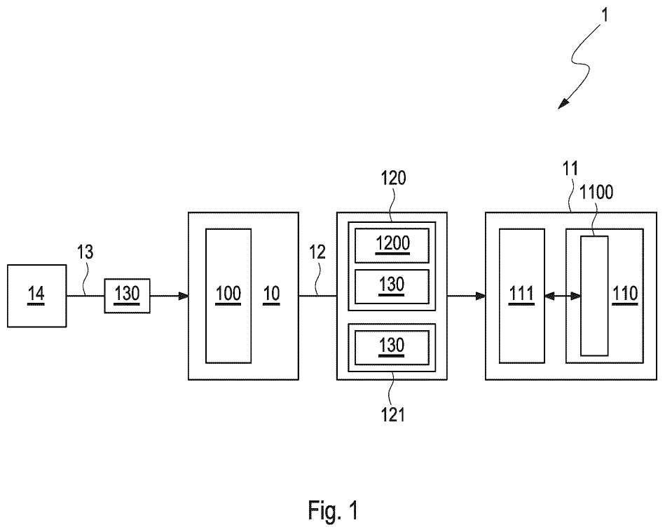

FIG. 1 schematically shows a partial diagram of a cellular network 1 synchronized by a method according to the invention. The cellular network 1 comprises a base transceiver station, BTS, 10 as a first node of the cellular network 1. The BTS 10 may be configured as a gNodeB specified by 5G standard. The BTS 10 may comprise a precision time protocol, PTP, client 100.

The cellular network 1 further comprises a terminal device 11 connected to the cellular network 1 as a second node of the cellular network 1. The terminal device 11 may comprise a PTP master 111 and a user application 110. The user application 110 may comprise a PTP client 1100.

Each of the BTS 10 and the terminal device 11 may be respectively implemented via a computing device and a computer program product. The computer program product comprises a computer-readable medium storing a program code causing the computing device to participate in a method according to the invention as a BTS 10 and as a terminal device 11, respectively, when being executed by a processor of the computing device.

The nodes of the cellular network 1 are synchronized by carrying out an inventive method as follows.

The BTS 10 wirelessly transmits clock information 1200 to the terminal device 11 connected to the cellular network 1 according to a first communication protocol.

The BTS 10 further transmits a clock accuracy information to the terminal device 11 according to the first communication protocol. The gNodeB preferably transmits the clock accuracy information as the BTS 10. The clock accuracy information is preferably transmitted once a second.

The clock accuracy information is specified by a second communication protocol different from the first communication protocol. Particularly, a network layer of the first communication protocol is different from a network layer of the second communication protocol and/or a networking plane of the first communication protocol is different from a networking plane of the second communication protocol.

Each of the clock information 1200 and the clock accuracy information may be transmitted according to the radio resource control, RRC, protocol 12 as the first communication protocol. The BTS 10 preferably transmits the clock accuracy information 130 as a part of SIB, an RRC message and/or an RRC information specified by the RRC protocol 12.

The clock accuracy information may be specified by the precision time protocol, PTP, 13 as the second communication protocol. The BTS 10 preferably transmits the PTP clock accuracy information 130 as a part of a master information block, MIB, 120 specified by the RRC protocol 12 or as a part of a system information block, SIB, specified by the RRC protocol 12.

The BTS 10 may transmit the PTP clock accuracy information 130 as a part of of a SIB1 121 or as a part of a SIB9 121 specified by the RRC protocol 12. The BTS 10 may transmit the PTP clock accuracy information 130 via a broadcast channel, BCH, or via a download shared channel, DL-SCH.

The PTP client 100 of the BTS 10 may receive a PTP announce message from a third node 14 of the cellular network 1 and transmit content of the received PTP announce message as the clock accuracy information. A clockClass value, a clockAccuracy value and/or an offsetScaledLog Variance value are preferably transmitted as the content.

The PTP master 111 executed by the terminal device 11 may receive the PTP clock accuracy information 130. The PTP client 1100 of the user application 110 executed by the terminal device 11 may receive the PTP clock accuracy information 130 from the PTP master 111. The terminal device 11 or a user application 110 executed by the terminal device 11 preferably executes a best master clock algorithm, BMCA, dependent of the received PTP clock accuracy information 130.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### REFERENCE NUMERALS

1 cellular network
10 BTS
100 PTP client
11 terminal device
110 user application
1100 PTP client
111 PTP master
12 RRC protocol
120 MIB
1200 clock information
121 SIB
13 PTP
130 PTP clock accuracy information
14 third node

1. A method for synchronizing nodes of a cellular network, comprising:
a base transceiver station (BTS), as a first node of a cellular network, wirelessly transmits a clock information to a terminal device connected to the cellular network as a second node of the cellular network according to a first communication protocol; and
the BTS transmits clock accuracy information to the terminal device according to the first communication protocol, wherein the clock accuracy information is specified by a second communication protocol different from the first communication protocol.

2. The method according to claim 1, wherein a network layer of the first communication protocol is different from a network layer of the second communication protocol; and/or
wherein a networking plane of the first communication protocol is different from a networking plane of the second communication protocol.

3. The method according to claim 1, wherein each of the clock information and the clock accuracy information is transmitted according to the radio resource control (RRC) protocol as the first communication protocol, and wherein the clock accuracy information is specified by the precision time protocol (PTP) as the second communication protocol.

4. The method according to claim 3, wherein the BTS transmits the PTP clock accuracy information as a part of an RRC message and/or an RRC information specified by the RRC protocol.

5. The method according to claim 3, wherein the BTS transmits the PTP clock accuracy information as a part of a master information block (MIB) specified by the RRC protocol or as a part of a system information block (SIB) specified by the RRC protocol.

6. The method according to claim 5, wherein the BTS transmits the PTP clock accuracy information as a part of an SIB1 or as a part of an SIB9 specified by the RRC protocol.

7. The method according to claim 5, wherein the BTS transmits the PTP clock accuracy information via a broadcast channel (BCH) or via a download shared channel (DLSCH).

8. The method according to claim 3, wherein a PTP client of the BTS receives a PTP announce message from a third node of the cellular network and transmits content of the received PTP announce message as the clock accuracy information.

9. The method according to claim 8, wherein a clockClass value, a clock Accuracy value and/or an offsetScaledLog Variance value are transmitted as the content.

10. The method according to claim 3, wherein a PTP master executed by the terminal device receives the PTP clock accuracy information.

11. The method according to claim 10, wherein a PTP client of a user application executed by the terminal device receives the PTP clock accuracy information from the PTP master.

12. The method according to claim 3, wherein the terminal device or a user application executed by the terminal device executes a best master clock algorithm (BMCA) dependent of the received PTP clock accuracy information.

13. The method according to claim 1, wherein the clock accuracy information is transmitted once a second.

14. The method according to claim 1, wherein a gNodeB transmits the clock accuracy information as the BTS.

15-16. (canceled)

17. A non-transitory computer-readable medium having processor-executable instructions stored thereon for synchronizing nodes of a cellular network, wherein the processor-executable instructions, when executed, facilitate performance of the following:
a base transceiver station (BTS), as a first node of a cellular network, wirelessly transmits clock information to a terminal device connected to the cellular network as a second node of the cellular network according to a first communication protocol; and
the BTS transmits clock accuracy information to the terminal device according to the first communication protocol, wherein the clock accuracy information is specified by a second communication protocol different from the first communication protocol.
